(19) United States
(12) Patent Application Publication
(10) Pub. No.: US 2014/0246371 A1
(43) Pub. Date: Sep. 4, 2014

(54) PROCESS FOR REMOVING SULFATE AND SYSTEM FOR SAME

(71) Applicants: Jiasheng Cao, The Woodlands, TX (US); Ronald M. Matherly, Sugar Land, TX (US); Daryl D. McCracken, Houston, TX (US); Evan K. Dawson, Houston, TX (US); Kushal Seth, Houston, TX (US)

(72) Inventors: Jiasheng Cao, The Woodlands, TX (US); Ronald M. Matherly, Sugar Land, TX (US); Daryl D. McCracken, Houston, TX (US); Evan K. Dawson, Houston, TX (US); Kushal Seth, Houston, TX (US)

(73) Assignee: Baker Hughes Incorporated, Houston, TX (US)

(21) Appl. No.: 13/782,206

(22) Filed: Mar. 1, 2013

(51) Int. Cl. C02F 1/52; C02F 1/66

(52) U.S. Cl. CPC C02F 1/5236; C02F 1/66
USPC 210/638; 210/717; 210/667; 210/192

(57) ABSTRACT

A process for removing sulfate includes combining a calcium compound and a fluid comprising sulfate to form a composition; adjusting the pH to be greater than or equal to 12; introducing, to the composition, an electrode comprising aluminum or a noble metal; contacting the composition with a material comprising aluminum if aluminum is absent from the electrode; applying a voltage to the electrode to oxidize the aluminum and to form aluminum ions; contacting the composition with the aluminum ions; and forming a precipitate to remove sulfate from the composition, the precipitate having a crystal structure including calcium, aluminum, and sulfate. A system for removing sulfate includes a first container to receive a composition comprising a calcium compound and a fluid comprising sulfate; a first transfer member to communicate the composition to a second container that includes a first electrode of and a second electrode to produce a precipitate of calcium, aluminum, and sulfate; and a second transfer member to communicate the precipitate and composition to a third container.

### BACKGROUND

Industrial, commercial, and residential use of water typically adulterates the water by addition of contaminating substances. In residential systems, a common adulterant is spent laundry detergent, which contains large amounts of sulfates. In commercial and industrial settings, water is used as a coolant, drainage agent, dilution compound, solvent, and the like. A particular use of water in some commercial environments involves power washing of objects such as sidewalks and buildings. Additionally, even if not involved directly in operations, water can become part of industrial settings as in mining where pools of water collect in shafts, abandoned mine tunnels, open mine strips, and similar features. These pools of water collect vast amounts of minerals and acids. A common issue with each area of use is the accumulation of hard water ions, e.g., divalent alkali metals, and anions that include sulfate. Water treatment can be costly and time consuming and may not reduce contaminants in the water below a level such that the water can be used or to a level for potability or portability.

The development of processes and systems that can be used to treat water to decrease various substances in the water is very desirable.

### BRIEF DESCRIPTION

The above and other deficiencies are overcome by, in an embodiment, a process for removing sulfate, the process comprising: combining a calcium compound and a fluid comprising sulfate to form a composition; adjusting a pH of the composition to a value greater than or equal to 12; introducing, to the composition, an electrode comprising aluminum or a noble metal; contacting the composition with a material comprising aluminum if aluminum is absent from the electrode; applying a voltage to the electrode to oxidize the aluminum and to form aluminum ions; contacting the composition with the aluminum ions; and forming a precipitate to remove sulfate from the composition, the precipitate having a crystal structure comprising calcium, aluminum, and sulfate.

In a further embodiment, a system for removing sulfate from a fluid comprises: a first container to receive a composition comprising a calcium compound and a fluid comprising sulfate; a first transfer member to communicate the composition from the first container to a second container, the second container comprising: a first electrode comprising aluminum or a noble metal; and a second electrode configured to connect electrically to the first electrode, wherein the second container is configured to produce aluminum ions in response to application of a voltage to the first electrode and to produce a precipitate having a crystal structure comprising calcium, aluminum, and sulfate in response to communication of the composition into the second container and production of the aluminum ions; and a second transfer member to communicate the precipitate and composition to a third container, the third container being configured to separate the precipitate and composition.

### BRIEF DESCRIPTION OF THE DRAWING

The following descriptions should not be considered limiting in any way. With reference to the accompanying drawings, like elements are numbered alike:

FIG. 1 shows a system for removing material from a fluid according to an embodiment described herein;

FIG. 2 shows a system for removing material from a fluid according to another embodiment described herein;

### DETAILED DESCRIPTION

A detailed description of one or more embodiments is presented herein by way of exemplification and not limitation.

It has been found that various chemical species including ions can be separated and removed from water by addition of material to the water and subjecting the resulting water composition to electrocoagulation. The treatment is efficient and produces water that retains low amounts of the chemical species. Some species are nearly quantitatively removed from the water. As a result, the water can be reused or safely disposed.

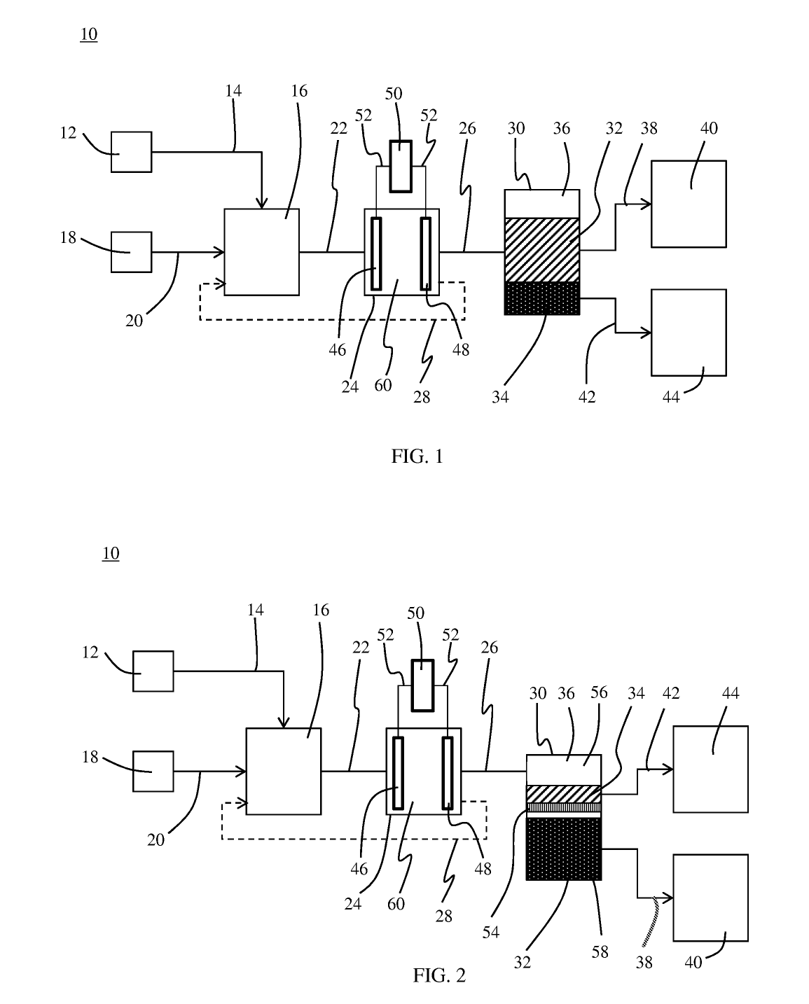

FIG. 1 shows an embodiment of a system for removing a chemical species from a fluid. The system 10 includes a first source 12 to provide a treatment agent to a first container 16 via a transfer member 14. A fluid for treatment is communicated from a second source 18 through a transfer member 20 to the first container 16 where the fluid is combined with the treatment agent. Combining the treatment agent and the fluid produces a composition, which is transferred from the first container 16 through a transfer member 22 to a second container 24. A first electrode 46 and a second electrode 48 can be disposed in the composition in the second container 24. The first and second electrodes (46, 48) can be electrically connected by wires 52 with a power source 50 therebetween.

The power source 50 is configured to apply a voltage difference to the first and second electrodes (46, 48) that causes an electrochemical reaction to occur at the first and second electrodes (46, 48). In one embodiment, the first electrode 46 is an anode that includes an anode material and which oxidizes in response to the applied voltage from the power source 52 such that ions of the anode material are released from the first electrode 46 into the composition. In this regard, the second electrode 48 is a cathode that includes a cathode material. The cathode material can cause the reduction of a component (e.g., a solute, solvent, molecular, atom, particle, and the like) in the composition by donation of an electron to the component upon application of the voltage from the power source 50 to the second electrode. In another embodiment, the polarity of the voltage delivered to the first electrode 46 and the second electrode 48 can be swapped such that the first electrode 46 is a cathode, and the second electrode 48 is an anode. Swapping the polarity can occur, e.g., by switching the wires 52 at the power source 50 or at the first and second electrodes (46, 48), by using a switching system between the power source 50 and the first and second electrodes (46, 48), or by using a power source 50 that is configured to switch a polarity among its output, and the like.

In an embodiment, the second container 24 can be a counter electrode to the first electrode 46 so that a second electrode 48 need not be present. Here, the second container 24, can be grounded or can be isolated from ground and biased by, e.g., the power source 50. In another embodiment, the second container 24 can include a surface that can have a potential applied to it from power source 50 so that the surface is a counter electrode to the first electrode 46, and the second electrode 48 can or cannot be present.

Without wishing to be bound by theory, electrocoagulation produces a precipitate from the ions of the anode material and components of the composition. In an embodiment, a component of the treatment agent, fluid, and the ions of the anode material forms the precipitate. According to an embodiment, the precipitate includes a reaction product of the composition and ions from the anode material.

In an embodiment, the system has a transfer member 28 to return the composition with or without the precipitate to the first container 16 from the second container 24. In this manner, the composition can be recycled between the first container 16 and the second container 24 by using transfer member 22 to perform transfer from the first container 16 to the second container 24 and using transfer member 28 to transfer from the second container 24 to the first container 16. In some embodiments, transfer member 22 can communicate bi-directionally so that the composition can be communicated from the first container 16 to the second container 24, and subsequently the composition with or without the precipitate can be communicated through transfer member 22 from the second container 24 to the first container 16. Once the composition or precipitate is disposed from the second container 24 to the first container, additional treatment agent or fluid can be introduced respectively from the first source 12 or second source 18 and combined with the contents of the first container 16 and thereafter communicated therefrom to the second container 24 through the transfer member 22. Upon disposal into the second container 24, the composition is subjected to electrocoagulation by introduction of the first electrode 46 and second electrode 48 with application of the voltage thereto from the power source 50 to form a precipitate.

It is contemplated that there is no upper limit on the number of times such recycling or exchange of the composition or precipitate can occur between the first container 16 and the second container 24. For reasons such as maintenance or varying the operability of the system, recycling the composition from the second container 24 to the first container 16 can occur as little as once or as many as times as desired, e.g., tens, hundreds, thousands, or even more times. Further, the composition can be communicated from the second container 24 to the first container 16 before or after application of the voltage to the first electrode 46 or the second electrode 48. In this manner, more material from the fluid can be used to form the precipitate and removed from the fluid.

The system further includes a transfer member 26 to communicate the composition and precipitate from the second container 24 to a third container 30. The third container is configured to separate the precipitate and the composition. In an embodiment, the combination of precipitate and composition can be separated into various phases or densities. The precipitate can separate from the composition into a precipitate layer 34 in the third container 30, and the composition, which can be substantially or completely free of the precipitate can be disposed in composition layer 32. In some embodiments, the third container can contain a headspace 36 for accommodating other layers from the separation of the composition or addition of an additional component, e.g., a gas to pressurize the third container 36. Consequently, the third container 36 can include multiple layers from the separation of the composition and precipitate respectively into a composition layer 32 and precipitate layer 34. The composition layer 32 can include multiple layers that separate by phase such as an aqueous phase, hydrophobic phase, hydrophilic phase, solid phase, or a combination thereof.

According to an embodiment, the third container provides a quiescent environment to allow spatial separation of the precipitate from the composition. Such separation can include the precipitate settling out of the composition due to gravity. Left undisturbed without a motional disturbance (e.g., shaking, vibrating, stirring, and the like), the precipitate can be partitioned from the composition to form the precipitate layer 34, and the composition (partially, substantially, or completely free of the precipitate) can form the composition layer 32.

In an embodiment, as shown in FIG. 2, the third container can include a physical partition 54 that separates a lower portion 56 and an upper portion 58 in the third container 30. Here, an effluent (e.g., composition and precipitate) from the transfer member 26 and the second container 24 is disposed on an upper surface of the physical partition 54. Liquid phase material traverses the physical barrier 54 from the upper portion 56 to the lower portion 58 of the third container 30 to produce a composition layer 32 disposed in the lower portion 58 and separated from a precipitate layer 34, which remains disposed on the upper surface of the physical partition 54 in the upper portion 56. The physical partition 54 can be a material that transmits the liquid but not the precipitate. Exemplary physical partitions include a membrane, filter, fret, cloth, wool, turnings, gel, and the like.

After separation of the precipitate and composition respectively into the precipitate layer 34 and the composition layer 32 within the third container 30, the precipitate layer 34 is removed from the third container 30 and communicated by a transfer member 42 to a precipitate container 44. Similarly, the composition layer 32 is removed from the third container 30 and communicated by a transfer member 38 to a fluid container 40. In an embodiment, a transfer member (not shown) can be used to communicate the composition from the fluid container 40 to the first container 16 or second container 24.

The transfer members (14, 20, 22, 26, 28, 38, 42) can include valves to isolate flow through a transfer member, a port to allow connection to an instrument or other container, flow meters to monitor or set the flow rate of the material being communicated, and the like. The transfer members can be tube, pipe, hose, and the like to allow fluid and particle communication between containers. In an embodiment, a pump can be interposed between containers (16, 24, 30, 40, 44) that are connected by a transfer member (14, 20, 22, 26, 28, 38, 42). The pump can urge flow of the composition or precipitate. Moreover, the pump or transfer member (14, 20, 22, 26, 28, 38, 42) can have unidirectional or bidirectional flow.

The containers (16, 24, 30, 40, 44) or sources (12, 18) can be made of an appropriate material that can provide chemical, physical, and material compatibility with the fluid, composition, treatment agent, first and second electrodes and their electrode materials, precipitate, and the like. The material for the containers (16, 24, 30, 40, 44) or sources (12, 18) can be, e.g., metal, polymer, glass, ceramic, and the like, or a combination thereof.

The containers (16, 24, 30, 40, 44) or sources (12, 18) can include a device to provide mixing, blending, or homogenization of material (e.g., the treatment agent and fluid to form the composition) therein. The device can be a paddle wheel, blade, fan, bubbler, effusor, and the like.

The power source 50 connected to the first and second electrodes (46, 48) can be a direct current (DC) power source that can be, e.g., a battery, fuel cell, power supply, solar array, or a combination thereof. In an embodiment, the power source 50 can be an alternating current (AC) power source. The power source 50 can include internal switching or can interface with an external switch to modulate application of the voltage to the first and second electrodes (46, 48). A capacitance network can be electrically connected to the power source 50 and first and second electrodes (46, 48) for impedance matching in order to couple the power from the power source 50 to the first and second electrode (46, 48).

According to an embodiment, the fluid can include a secondary material such as cations, anions, particles, and the like. The secondary material forms the precipitate in the second container. In an embodiment, the secondary material includes alkali metals cations (Mg²⁺, Ca²⁺, Sr²⁺, Ba²⁺, and the like), transition metal ions or neutral (e.g., Cr, Mn, Ni, Cu, Hg, Pb, Sn, and the like), rare earth ions or neutrals (e.g., Ce, U, and the like), anions (e.g., HCO₃⁻, CO₃²⁻, C₂O₄²⁻, SO₄²⁻, HSO₄⁻, PO₄³⁻, HPO₄²⁻, H₂PO₄⁻, SO₃²⁻, HSO3−, S²⁻, HS⁻, and the like), or a combination thereof. The fluid can also include a water (e.g., wash water, runoff, wastewater, industrial processed water, and the like), aqueous solutes (e.g., low molecular weight sugars, alcohols, esters, carboxylic acids, and the like), or a combination thereof. In a particular embodiment, the fluid includes a water and secondary material that includes sulfate.

The treatment agent combines with the fluid to form the composition that is subsequently contacted with ions from the anode material to form a precipitate. The treatment agent includes a calcium compound that can produce calcium ions in the fluid. Exemplary calcium compounds include CaO, Ca(OH)₂, CaCl₂, Ca(NO₃)₂, Ca(C₂H₃O₂)₂, Ca(HCO₃)₂, Ca²⁺, CaBr₂, CaH2, CaHPO₄, Ca(OH)₂, Ca(OCl)₂, CaI₂, CaMoO₄, CaC₂O₄, CaO₂, Ca₃(PO₄)₂, CaSiO₃, CaS, CaTiO₃, CaWO₄, CaZrO₃, calcium citrate, calcium benzoate, calcium formate, calcium gluconate, calcium glycerophosphate, calcium lactate, calcium salicylate, calcium succinate, a hydrate thereof, and the like, or a combination thereof. It is contemplated that various other inorganic or organic calcium compounds also can be used.

In an embodiment, the treatment agent includes a carbonate compound to produce carbonate ions, bicarbonate ions, an equilibrium product thereof, or a combination thereof in the composition. The carbonate compound can be, e.g., H₂CO₃, NaHCO₃, Na₂CO₃, MgCO₃, K₂CO₃, CaCO₃, MnCO₃, NiCO₃, ZnCO₃, Al₂(CO₃)₃, dimethyl carbonate, and the like, or a combination thereof. It is contemplated that addition of the carbonate compound can change or adjust the pH of the composition.

Once the fluid and the treatment agent are combined to form the composition, the composition forms a precipitate with ions from the anode material of, e.g., the first electrode 46. The anode material can include a transition metal, e.g., aluminum, iron, tungsten, vanadium, rhodium, zinc, nickel, copper, gold, and the like, or a combination thereof. According to an embodiment, the composition alternatively can form a precipitate with ions formed from a material comprising aluminum. Such material comprising aluminum, can be disposed anywhere in the second container 24, e.g., in a space 60 between the first electrode 46 and the second electrode 48. In an embodiment, the second electrode 48 and the first electrode 46 are the same or different materials. In another embodiment, the second electrode 48 and the first electrode 46 have different standard reduction potentials. In a particular embodiment, the second electrode 48 has a standard reduction potential that is greater than or equal to the standard reduction potential of the first electrode 46. The first or second electrodes (46, 48) can have any shape such as cylindrical, planar, round, circular, flat, concave, convex, and the like. Moreover, a plurality of first electrodes 46 can be electrically connected to a plurality of second electrodes 48 in a series or parallel arrangement or combination thereof. The first or second electrode (46, 48) can have pores, have a rough surface, or have a foam structure to increase a surface area thereof, which can increase the rate of oxidation or reduction that occurs at the electrode (46, 48).

In an embodiment, the first electrode 46 includes aluminum, which is released as aluminum ions (Al³⁺, etc.) in response to application of voltage from the power source 50. The composition containing sulfate and the calcium compound contacts the aluminum ions from the first electrode 46 to produce the precipitate. In an embodiment, the precipitate includes calcium, aluminum, and sulfate; specifically (CaO)ₓ(Al(OH)₃)_{y}(CaSO₄)_{z}.nH₂O, (CaO)ₓ(Al₂O₃)_{y}(CaSO₄)_{z}.nH₂O, CaₓAl_{y}(SO₄)_{z}(OH)_{w}.26H₂O, or a combination thereof, wherein w, x, y, z, and n are independently a rational number from 0 to 36, and z is greater than or equal to 1, such that at least x+y+z is greater than or equal to 3. More specifically, the precipitate can be (CaO)₆(Al₂O₃)(CaSO₄)₃.32H₂O, (CaO)₃(Al₂O₃)(CaSO₄)₃.32H₂O, Ca₆Al₂(SO₄)₃(OH)₁₂.26H₂O; and even more specifically ettringite, CaSO₄, Al₂O₃, CaO, Al(OH)₃, a hydrate thereof, or a combination thereof. According to an embodiment, the precipitate has a crystal structure that includes calcium, aluminum, and sulfate in the crystal structure. As herein, “precipitate” includes crystalline, semi-crystalline, and amorphous structures including flocs, colloidal particles, aggregates, and the like.

The calcium compound and aluminum ions can be present in an amount effective to form the precipitate. The calcium ions from the calcium compound can be used to adjust the pH of the composition to a pH effective to form the precipitate. In an embodiment, the pH is greater than or equal to 7, specifically greater than or equal to 10, greater than or equal to 11, and more specifically greater than or equal to 12.

The system herein can be used to form the precipitate by disposing an ion produced from an electrochemical reaction into the composition. According to an embodiment, a process for removing sulfate from a fluid includes combining a calcium compound and a fluid comprising sulfate to form the composition and adjusting a pH of the composition to a value greater than or equal to 12. An electrode comprising aluminum or noble metal is introduced to the composition. When the electrode does not include aluminum, a material comprising aluminum can be disposed in the composition to contact the composition and to produce aluminum ions in the composition. A voltage is applied to the electrode to oxidize and dissolve the aluminum and to form aluminum ions, which contact the composition. The composition can include calcium ions or stable calcium compounds (e.g., CaO) produced from the calcium compound. Additionally, a counter electrode can be introduced to the composition, wherein the counter electrode includes a metal having a standard reduction potential that is greater than or equal to that of the electrode comprising aluminum. The noble metal can be, e.g., gold, platinum, iridium, palladium, osmium, silver, rhodium, ruthenium, or a combination thereof. The material comprising aluminum can be aluminum, an alloy thereof, and the like. It is contemplated that the material comprising aluminum can be any form or shape effective to be reduced and produce aluminum ions upon application of a voltage to the electrode. In an embodiment, the material comprising aluminum is a sheet, cylinder, particles, foam, windings, bar, coil, mesh, and the like. In some embodiments, the electrode is aluminum. In an embodiment, the electrode is aluminum and additional aluminum can be present in the second container such as an aluminum sheet disposed in the second container and in contact with the composition. It should be noted that the material comprising aluminum does not short circuit the electrocoagulation operation of the second unit.

The process also includes forming a precipitate from the composition to remove sulfate from the composition, the precipitate having a crystal structure comprising calcium, aluminum, and sulfate. Since formation of the precipitate or a structure or composition of the precipitate can depend upon the pH of the composition, the pH of the composition can be adjusted by changing a concentration of the calcium ions in the composition. In an embodiment, changing the concentration of the calcium ions entails increasing or decreasing the amount of the calcium compound introduced to the composition. It should be appreciated that additional calcium compound can be introduced into the composition during, before, or after application of the voltage to the first electrode. Moreover, since the voltage can be modulated, i.e., switched on and off, the calcium compound can be added in discrete quantities in varying amounts.

After forming the precipitate, the precipitate is separated from the composition. Separating the precipitate from the composition can include quiescent settling of the precipitate out of the composition. In addition, water can be separated from the composition as well. In some embodiments, the process can be repeated prior to separating the precipitate and water from the composition. According to an embodiment, the process can further include treating the composition to remove more precipitate, further purify the composition, or isolate a particular substance from the composition. Exemplary treatments include filtration, air stripping, ion exchange, chemical precipitation, chemical oxidation, carbon adsorption, ultrafiltration (UF), reverse osmosis (RO), electrodialysis, volatilization, gas stripping, or a combination thereof.

In an embodiment, additional compounds can be added to the composition to increase the number of chemical species that precipitate and eventually are removed from the composition. A magnesium compound can be introduced into the composition to produce magnesium ions so that a second precipitate comprising a reaction product of the composition and the magnesium ions is formed. The second precipitate can complex or agglomerate with the precipitate comprising calcium, aluminum, and sulfate. In one embodiment, a carbonate compound is introduced into the composition to produce carbonate ions, bicarbonate ions, an equilibrium product thereof, or a combination thereof. Here, a third precipitate can form that includes a reaction product of the composition and the carbonate ions, bicarbonate ions, an equilibrium product thereof, or a combination thereof. Again, the third precipitate can complex or agglomerate with the precipitate comprising calcium, aluminum, and sulfate, the second precipitate, or a combination thereof.

The formation of the precipitate can occur at room temperature. In an embodiment, the temperature during the process can be from slightly above the freezing point of water to slightly below the boiling point of water, specifically from 5° C. to 95° C., more specifically 15° C. to 80° C., and more specifically from 20° C. to 50° C. The pressure during the process can be any pressure effective to form or separate the precipitate from the composition, e.g., from 0.1 pascal (Pa) to 250 megapascals (MPa), specifically 50 kilopascals (kPa) to 100 MPa, and more specifically 100 kPa to 500 kPa.

The process is facile, efficient, and greatly reduces the amount of ions (e.g., sulfate, magnesium, calcium, and the like) present in the composition after removal of the precipitate therefrom. According to an embodiment, formation of the precipitate from introduction of the composition to the electrodes and application of the voltage to the electrodes is performed from 30 seconds to 1 week, specifically 1 minute to 5 hours, more specifically 1 minute to 1 hour, and more specifically 5 minutes to 15 minutes. In a further embodiment, an amount of sulfate present in the composition is less than or equal to 500 parts per million (ppm), specifically 200 ppm, and more specifically 50 ppm, after separating the precipitate from the composition. An amount of magnesium ions present in the composition can be less than or equal to 200 ppm, specifically 50 ppm, and more specifically 10 ppm after separating the precipitate from the composition. In an embodiment, an amount of calcium ions present in the composition is less than or equal to 300 ppm, specifically 150 ppm, and more specifically 70 ppm after separating the precipitate from the composition. In some embodiments, the amount of sulfate present in the composition after separating the precipitate from the composition is less than or equal to 5% of the initial amount of sulfate in the fluid, specifically 1%, and more specifically 0.5%.

Consequently, the process herein removes a high percentage of sulfate and other secondary material from fluids such as waste water that can contain high concentrations of sulfates or a small concentration of calcium. Sulfate is removed by forming stable precipitates with aluminum and calcium ions or neutrals. Near quantitative removal of other contaminants, including metal ions, suspended solids, or inorganic anions (bicarbonates) can be accomplished as well. The treated water can be pure enough to be reused or disposed.

The process and system herein have numerous uses, e.g., for mobile water treatment and service. Additionally, the precipitate can be used as coagulation agent. In an embodiment, the precipitate can be combined with a downhole fluid, e.g., brine, mud, or cement, and used in a downhole process including fracing, cementing, and the like.

The process and system herein for precipitate formation and removal from a fluid are further illustrated by the following non-limiting examples.

### EXAMPLE 1

Synthetic water was prepared by combining Na₂SO₄, MgCl₂, CaCl₂, NaHCO₃, NaCl, and tap water to obtain 2 gallons of synthetic water in a mixing container. Thereafter, 10 g CaO and 10 g CaCl₂ were added to the synthetic water and mixed for 5 minutes. The pH of the composition was 12.28 as measured with an electronic pH probe. Aliquots of the composition were withdrawn from the container, and the initial concentrations of ions in the composition were determined by inductively coupled plasma spectrometry, results of which are listed in Table 1.

The composition was transferred into an electrocoagulation (EC) unit equipped with an aluminum or noble metal anode and an aluminum, iron, or_ noble metal_ cathode. A voltage difference of 20 volts was applied to the anode and cathode at 50 amps to subject the composition to electrocoagulation for a 5-minute residence time in the EC unit before removal from the EC unit and disposal in a separation unit. The resulting composition containing precipitate was filtered using a 25 um filter media. The liquid portion was collected and analyzed by ICP spectrometry, and the results for the concentration of the remaining ions in the liquid are listed in Table 1, which lists ionic species before and after treatment.

TABLE 1

| | | Influent | Effluent |
|---|---|---|---|
| | | Concentration | Concentration |
| Water sample | Ionic Species | (ppm) | (ppm) |
| Synthetic | SO₄²⁻ | 1600 | <20 |
| | Mg²⁺ | 86.2 | <1 |
| | Ca²⁺ | 192 | 66 |
| | HCO₃⁻ | 280 | <10 |

### EXAMPLE 2

Acid mine water (AMD) was collected from a filed mine A composition was prepared by combining 60 milliliters (mL) of liquid Ca(OH)₂ and 2 gallons AMD in a container and mixing for 5 minutes. The pH of the composition was 12.85 as measured with an electronic pH probe. Aliquots of the composition were withdrawn from the container, and the initial concentrations of ions in the composition were determined by inductively coupled plasma spectrometry, results of which are listed in Table 2.

The composition was transferred into the EC unit equipped with an aluminum or noble metal anode and an aluminum, iron, or noble metal_ cathode. A voltage difference of 20 volts was applied to the anode and cathode at 50 amps to subject the composition to electrocoagulation for a 5-minute residence time in the EC unit before removal from the EC unit and disposal in a separation unit. The resulting composition containing precipitate was filtered using a 25 μm filter media. The liquid portion was collected and disposed in a container to which 60 milliliters (mL) of liquid Ca(OH)₂ was added and the resulting composition mixed for 5 minutes. The pH of the composition was determined to be 12.80.

The composition was transferred to the EC with a 20 volt difference applied to the anode and cathode at 50 amps to subject the composition to electrocoagulation for a 5-minute residence time in the EC unit before removal from the EC unit and disposal in a separation unit. The resulting composition containing precipitate was filtered using a 25 μm filter media. The liquid portion was collected and analyzed by ICP spectrometry, and the results for the concentration of the remaining ions in the liquid are listed in Table 2, which lists ionic species before and after treatment.

TABLE 2

| | | Influent | Effluent |
|---|---|---|---|
| | | Concentration | Concentration |
| Water sample | Ionic Species | (ppm) | (ppm) |
| AMD | SO₄²⁻ | 2700 | <10 |
| | Mg²⁺ | 95.6 | <1 |
| | Ca²⁺ | 185.6 | 68.5 |
| | HCO₃⁻ | 287 | <10 |

While one or more embodiments have been shown and described, modifications and substitutions may be made thereto without departing from the spirit and scope of the invention. Accordingly, it is to be understood that the present invention has been described by way of illustrations and not limitation. Embodiments herein are can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive; rather the elements can be used separately or can be combined together under appropriate circumstances.

What is claimed is:

1. A process for removing sulfate, the process comprising:
combining a calcium compound and a fluid comprising sulfate to form a composition;
adjusting a pH of the composition to a value greater than or equal to 12;
introducing, to the composition, an electrode comprising aluminum or a noble metal;
contacting the composition with a material comprising aluminum if aluminum is absent from the electrode;
applying a voltage to the electrode to oxidize the aluminum and to form aluminum ions;
contacting the composition with the aluminum ions; and
forming a precipitate from the composition to remove sulfate from the composition, the precipitate having a crystal structure comprising calcium, aluminum, and sulfate.

2. The process of claim 1, further comprising separating the precipitate from the composition.

3. The process of claim 2, further comprising combining the precipitate with a downhole agent to form a downhole fluid.

4. The process of claim 2, further comprising separating water from the composition.

5. The process of claim 4, further comprising repeating the process of claim 1 prior to separating the precipitate and water from the composition.

6. The process of claim 2, further comprising quiescently settling the precipitate out of the composition.

7. The process of claim 1, further comprising introducing a counter electrode to the composition, the counter electrode comprising a metal having a standard reduction potential which is greater than or equal to that of the electrode comprising aluminum.

8. The process of claim 1, further comprising producing calcium ions from the calcium compound.

9. The process of claim 8, wherein adjusting the pH of the composition comprises changing a concentration of the calcium ions in the composition.

10. The process of claim 1, further comprising treating the composition by filtration, air stripping, ion exchange, chemical precipitation, chemical oxidation, carbon adsorption, ultrafiltration, reverse osmosis, electrodialysis, volatilization, gas stripping, or a combination thereof.

11. The process of claim 1, further comprising introducing magnesium compound into the composition, wherein the magnesium compound produces magnesium ions in the composition.

12. The process of claim 11, further comprising forming a second precipitate comprising a reaction product of the composition and the magnesium ions.

13. The process of claim 1, further comprising introducing a carbonate compound into the composition;
producing carbonate ions, bicarbonate ions, an equilibrium product thereof, or a combination thereof in the composition from the carbonate compound; and
forming a third precipitate comprising a reaction product of the composition and the carbonate ions, bicarbonate ions, an equilibrium product thereof, or a combination thereof.

14. The process of claim 1, wherein the calcium compound comprises, lime, CaO, Ca(OH)₂, CaCl₂, Ca(NO₃)₂, Ca(C₂H₃O₂)₂, Ca(HCO₃)₂, Ca²⁺, CaBr₂, CaH2, CaHPO₄, Ca(OH)₂, Ca(OCl)₂, CaI₂, CaMoO₄, CaC₂O₄, CaO₂, Ca₃(PO₄)₂, CaSiO₃, CaS, CaTiO₃, CaWO₄, CaZrO₃, calcium citrate, calcium benzoate, calcium formate, calcium gluconate, calcium glycerophosphate, calcium lactate, calcium salicylate, calcium succinate, a hydrate thereof, or a combination thereof.

15. The process of claim 1, wherein the precipitate comprises (CaO)ₓ(Al(OH)₃)_{y}(CaSO₄)_{z}.nH₂O, (CaO)ₓ(Al₂O₃)_{y}(CaSO₄)_{z}.nH₂O, CaₓAl_{y}(SO₄)_{z}(OH)_{w}.26H₂O, or a combination thereof,
wherein w, x, y, z, and n are independently a rational number from 0 to 36, and z is greater than or equal to 1, such that at least x+y+z is greater than or equal to 3.

16. The process of claim 1, wherein the calcium compound is present in the composition in an amount effective to form the precipitate.

17. The process of claim 2, wherein an amount of sulfate present in the composition is less than or equal to 50 ppm after separating the precipitate from the composition.

18. The process of claim 2, wherein an amount of magnesium ions present in the composition is less than or equal to 10 ppm after separating the precipitate from the composition; or the amount of calcium ions present in the composition is less than or equal to 70 ppm after separating the precipitate from the composition.

19. A system for removing sulfate from a fluid, the system comprising:
a first container to receive a composition comprising a calcium compound and a fluid comprising sulfate;
a first transfer member to communicate the composition from the first container to a second container, the second container comprising:
a first electrode comprising aluminum or a noble metal; and
a second electrode configured to connect electrically to the first electrode,
wherein the second container is configured to produce aluminum ions in response to application of a voltage to the first electrode and to produce a precipitate having a crystal structure comprising calcium, aluminum, and sulfate in response to communication of the composition into the second container and production of the aluminum ions; and
a second transfer member to communicate the precipitate and composition to a third container, the third container being configured to separate the precipitate and composition.

20. The system of claim 19, further comprising a third transfer member to communicate the composition from the second container to the first container.
